(19) United States
(12) Patent Application Publication
(10) Pub. No.: US 2011/0048900 A1
(43) Pub. Date: Mar. 3, 2011

(54) AUTOMATED LOADING AND UNLOADING PRODUCE ACCUMULATOR

(76) Inventor: Joseph Dean Wiggins, Snook, TX (US)

(21) Appl. No.: 12/550,476

(22) Filed: Aug. 31, 2009

(51) Int. Cl. B65G 13/02

(52) U.S. Cl. 198/780

(57) ABSTRACT

An apparatus for mechanically, safely, and efficiently accumulating, transporting, and unloading produce.

### FIELD OF THE INVENTION

The present invention pertains to the field of accumulating, gathering, transporting, and unloading agricultural produce.

### BACKGROUND OF THE INVENTION

Harvesting many types of agricultural produce is extremely labor intensive. Direct labor costs are constantly rising, as are indirect labor costs such as the liability associated with workers engaged in repetitive, strenuous work. Commercial viability of a seasonal, labor intensive process in today's global market is highly dependent on a dwindling labor base of workers willing to follow the growing seasons. There is a need for a reduction in labor cost and an increase in productivity that can only be met with a means of mechanically loading, accumulating, transporting, and unloading produce. Also, that need must be met with an apparatus that does not damage delicate agricultural products such as watermelons, cantaloupes, pumpkins, and squash. For example, there is a need for an apparatus capable of economically accumulating and disgorging high volumetric rates (1000 to 2000 pounds per minute) of watermelons with a minimum of crop damage.

In the state-of-the-art watermelon industry, harvesting watermelons is complex, strenuous, and expensive. If done strictly manually, the process requires repetitive bending and heavy lifting, and the resultant worker fatigue makes the manual labor process practical only with the availability of labor reserves large enough for worker rotation. And the strenuous work dictates the predominate use of young workers, the labor force that has the highest turnover rate.

Watermelons are typically planted in groups of four to six parallel rows situated between unplanted rows wide enough to accommodate harvest vehicles. At harvest time, skilled workers called cutters traverse the planted rows, cut mature fruit from the vine, and place it belly (light-colored) side up so that it can be identified by the workers who later load the melons on the harvest vehicle. A crew of ten skilled cutters is capable of selecting for harvest between 300,000 and 400,000 pounds of watermelons in ten hours.

After the cutters have done their job, a bobtail (box) truck, or a truck or tractor pulling a trailer, slowly traverses the harvest rows while workers, at least two or three on each side of the trailer (one worker per crop row), walk the crop rows, lift the cut fruit from the ground, and pass it to each other until it is placed in the vehicle bed. One worker lifting a melon from the ground is not able to lift and pass that melon and simultaneously pass another melon from a second worker. Therefore, using four workers on each side of the harvest vehicle and one driver, the state-of-the-art process is typically limited to harvesting only two crop rows at a time, or approximately 30,000 pounds of watermelons per hour. Harvesting 480,000 pounds of watermelons would require two crews working eight hours (144 man hours).

One crew consisting of eight workers is capable of accumulating 30,000 pounds of watermelons per hour. That yield can be increased by attaching conveyors extending from either side of the vehicle far enough to permit simultaneous loading from more than two rows. However, an increase in the rate of melons coming to an accumulator without a concomitant increase in the ability to safely receive and stack the melons will cause a backup of melons, and will likely result in a significant increase in produce damage.

In the state-of-the-art watermelon industry, melons are unloaded using two methods, bin dumping or manual labor unloading.

One bin-dumping crew typically consists of three skilled workers equipped with three forklifts, several hundred bins, one conveyor belt line, and two bin dumpers. Such a crew is capable of unloading approximately 80,000 pounds per hour, but incurs additional labor costs due to the requirement for skilled forklift operators, and additional capital costs for dumpers, bins, and forklifts.

In the bin dumping unloading method, the watermelons are not accumulated in an open trailer or a truck bed. They are accumulated in bins that are delivered via truck or trailer to the packing facility where they are unloaded with forklifts. The bins are staged for in-feeding near the packing facility and later moved with forklifts to the packing line in-feed conveyor. The conveyor moves the bins to the dumping device that mechanically dumps the melons onto a conveyor that feeds the sizing machines. After being dumped, the empty bins are then conveyed to the end of the line where forklifts stage them for loading, or load them onto outgoing harvest vehicles.

In the manual unloading method, the harvest vehicle is either parked beside a conveyor belt or backed up to a telescoping belt. Workers then transfer the melons from the harvest vehicle to the belt that feeds them into the packing, preparing, or storing facility. Due to the strenuous nature of manual unloading, at least four workers from a 22 worker packing crew are generally periodically rotated into the unloading crew.

At the packing facility, a crew of 22 workers is required for unloading and packing 40,000 pounds of watermelons per hour. Each packing crew consists of four workers who unload the truck, one worker who grades the watermelons, one worker who separates the seeded and seedless melons, one worker who applies labels to the melons, three workers who pack the seeded watermelons, seven workers who pack the seedless watermelons, one worker who pulls filled bins from the line, and one worker who places lids on the bins. Therefore, a total of 220 man hours is required to unload and pack 400,000 pounds in a ten hour day.

A cost-effective goal for a watermelon farm, harvesting and packing 400,000 pounds per day, requires one crew of ten cutters working ten hours, two eight-man harvest crews and two truck drivers working eight hours, and one 22 man unloading/packing crew working ten hours. Therefore, in the state-of-the-art watermelon industry, 50 workers and a total of 464 man hours are typically required to cut, harvest, unload, sort, grade, label, and pack 400,000 lb. of watermelon a day.

The present invention accumulator without an in-feed conveyor also requires one crew of ten cutters working ten hours, but enables six workers and a driver to load approximately 30,000 pounds of watermelons per hour, or 240,000 pounds in an eight hour day. Harvesting and transporting to the packing facility the approximate 400,000 pounds per day objective would require one crew of ten cutters working ten hours and two six-man harvest crews and two truck drivers working eight hours—a total of 212 man hours.

An alternate embodiment of the present invention accumulator can be built with two 20-ft. conveyors that can move melons from two crop rows on either side of the harvest vehicle. Such a configuration makes it possible for the cutters to load the conveyors as they cut, eliminating the need for separate harvest crews. The conveyors enable four workers and one driver to load approximately 30,000 pounds of watermelons per hour, or 240,000 pounds in an eight hour day. Therefore, harvesting and transporting to the packing facility the approximate 400,000 pounds per day objective would require two four man cutter/harvester crews and two drivers working eight hours—a total of 80 man hours.

The labor savings demonstrated above relate only to the accumulation and transporting of melons. The present invention also offers significant labor savings in the unloading process. Regardless of which of the two aforementioned accumulator embodiments is used, the present invention permits a crew of 18 workers at a packing facility to unload and pack approximately 60,000 pounds of watermelons per hour.

Each packing crew consists of one worker who grades the watermelons, one worker who separates the seeded and seedless melons, one worker who applies labels to the melons, three workers who pack the seeded watermelons, seven workers who pack the seedless watermelons, one worker who places empty pallets, one worker who places empty bins, one worker who erects bins, one worker who pulls filled bins from the line, and one worker who places lids on the bins. Therefore, in seven hours, a crew of 18 workers, for a total of 126 man hours, is able to unload and pack 420,000 pounds of watermelons. If the packing crew works eight, rather than seven hours, to match the eight hours worked by the harvesting crews, the packing labor increases to 144 man hours.

Therefore, both embodiments of the present invention represent significant economy over the 464 man hours per day required by state-of-the-art methods. The present invention without conveyors reduces the total cutting, harvesting, unloading, sorting, grading, labeling, and packing labor for 400,000 lb. of watermelon per day from 464 to 356 man hours. The present invention with conveyors reduces the labor from 464 to 224 man hours.

Johnson (U.S. Pat. No. 5,073,081) describes and claims a stacking method whereby self-contained portable stacking modules assemble layers of items into a stack of predetermined height and width. The method relies on a machine that receives items and conveys them upwardly to a location above the machine. The machine is a robotic forklift that, working with one or more other forklifts depending on the length of the workpieces, receives workpieces from a conveyor and creates a stack of workpieces. The forklifts then move in unison laterally to a location where the stack is offloaded.

Johnson's claims limit the stacked items to elongate workpieces such as lumber, whereas the present invention is not limited to elongate items. Each of Johnson's stacking modules is motorized and self-contained and requires at least one other module to “temporarily” and “cooperatively” (see claim 1) raise the elongate workpieces. The produce-lifting baskets of the present invention do not require the cooperation of others to raise a layer of workpieces; each basket raises one layer of produce. Johnson's method forms stacks with no separation between layers, whereas the present invention elevates entire layers into stacked but separated locations.

De Greef (US published application 20080066429) describes and claims a method and apparatus for filling a container with delicate products (apples are the products mentioned in the description of the preferred embodiments). In contrast, the present invention does not operate to fill containers; it accumulates produce and delivers it to a receiving facility where container fillers may be employed. De Greef's apparatus transfers produce from a high plane to a low plane using essentially a vertical conveyor belt in the form of a rotating bristle brush. The result is fruit stacked upon fruit. In contrast, the present invention accumulates produce from a low plane and stages it on a high plane, thereby providing the novel capability of receiving produce at the level of a worker on the ground and automatically moving it vertically, one layer at a time, to a higher plane during the harvest process. De Greef's method and apparatus do not enable the present invention's capacity for accumulating produce heavier than apples. De Greef's description makes it obvious that his bristle brush transport device is inadequate for the weight of most, if not all, melons, particularly watermelons.

### SUMMARY OF THE INVENTION

The present invention accumulator overcomes state-of-the-art shortcomings, and significantly enhances the efficiency of accumulating and unloading produce. It can be mobile or stationary, and is designed to operate for many years in hot, humid environments. It provides efficient and safe accumulation and unloading of high volumes of watermelons and other heavy produce while requiring a significantly smaller work crew than that required by methods using state-of-the-art harvesting equipment. It is ergonomically designed to minimize the difficulty of placing heavy produce in a harvest vehicle. It eliminates the need for manual unloading of the harvest vehicle. It will be painted or coated with food-grade finishes. Elimination of fruit-on-fruit stacking and impingement during harvest reduces losses due to bruising and crushing. And, depending on which of the aforementioned embodiments is employed, the present invention offers a reduced daily labor count of between 108 and 240 man hours for harvesting, unloading, and packing 400,000 pounds of watermelons. That translates to a 23% to 52% reduction from state-of-the-art labor costs. The ultimate result is a higher crop yield at lower cost.

The accumulator can be designed for small, light produce such as citrus, pepper, and squash, and for large, heavy produce such as watermelons, cantaloupes, and honeydew melons. It can be used on bulk materials other than produce, for example, the accumulating, sorting, and cleaning of gravel. It can be used on manufactured goods such as balls and helmets.

The preferred embodiment accumulator is a trailer on which are mounted two accumulator modules, each populated with a parallel array of 22 five inch diameter, nine feet long roller brushes the longitudinal rotational axes of which are perpendicular to the longitudinal axis of the trailer. The brush bristles are made of 1¼ inch water resistant material. The brushes form a bed with adjacent brush peripheries separated by a ¼ inch gap. As the harvest vehicle travels the length of a crop field, produce is loaded onto a receiver device on the front end of the accumulator (corresponding to the front end of any trailer being pulled by another vehicle) by hand or a conveyor belt, and the rotating brushes move the produce toward the rear of the accumulator until the accumulator brush bed is full. Maximum capacity accumulation is facilitated with the aid of a slight slope from the front to the rear end of the brush bed. The brushes clean and polish the produce during the accumulation process.

Workers walking near the front of the accumulator feed the produce into the accumulator directly, or they load the produce onto a conveyor belt that feeds the produce onto the front end of the accumulator brush bed. The conveyor can be a single belt on one side of the accumulator, or two belts, one on each side of the accumulator. Variable conveyor speed coordinated with vehicle speed allows the operators in the field to control the rate at which fruit accumulates on the brush bed.

The gaps between adjacent brushes in the brush bed provide space for a basket made of properly sized pipes or beams to pass through on its way upward from beneath the brush bed. The basket lifts the produce from the brush bed and moves it upward to a predetermined staging level. FIG. 1 depicts four baskets positioned below the brush bed. When produce fills the brush bed, one basket moves upward under the influence of a cable, screw, or hydraulic drive system, clearing the produce from the brush bed. After produce again fills the brush bed, the second basket moves upward, picks up the second layer of produce, and moves it to a second staging level below the first staging level. FIG. 2 depicts three baskets in their raised positions (no fruit is shown). The sequence is repeated until all baskets are full and raised, and the accumulator can then be transported to a packing facility, processing plant, or sales outlet.

In the unfilled position below the brush bed, the baskets are nested or stacked so as to minimize their total height. When full and raised, baskets are vertically separated by a distance great enough to preclude crushing of the produce, about fifteen inches in the case of watermelons. Electronic eye (laser beam), electro-mechanical limit switches, or a combination thereof, can be used to prevent undesirable contact between baskets.

Upon arrival at a packing facility, the accumulator is backed up to a conveyor or brush bed designed to receive produce from the accumulator. The accumulator tailgate is lowered, raised, or removed, and the accumulator baskets are sequentially lowered to the level of the brush bed. Rotation of the accumulator brushes moves the produce toward the packing facility conveyor or brush bed until all the produce has been unloaded. If the accumulator is aligned with its front end mated to the receiving bed or conveyor, the accumulator brush rotation is reversed to facilitate unloading. After unloading, the accumulator returns to the field for repeated loadings.

### BRIEF DESCRIPTION OF THE DRAWINGS

FIG. 1 is a perspective view of two accumulator modules with the tailgate and all baskets in their lowered positions.

FIG. 2 is a perspective view of two accumulator modules with the tailgate and all baskets in their raised positions.

FIG. 3 is a side view of part of an accumulator module with all baskets in their lowered positions.

FIG. 4 is a side view of part of an accumulator module with all baskets in their raised positions.

FIG. 5 is a perspective view of the accumulator receiver.

### DETAILED DESCRIPTION OF THE PREFERRED EMBODIMENT

Terminology used herein describes particular embodiments only, and is not intended to be limiting. As used in the specification, including the claims, the singular forms “a”, “an”, and “the” include singular and plural referents unless the content dictates otherwise. Unless defined otherwise, all technical and scientific terms used herein have meanings commonly understood by one of ordinary skill in the relevant art or industry.

“Basket” herein generally refers to a structure capable of containment, in at least one direction, of objects.

“Deployable” herein generally refers to an action performed on or by an object that puts it in a position to perform a desired task or operation.

“Modular” herein generally refers to an apparatus capable of performing its design function as a single unit or in combination with conjoined replicas.

“Tailgate” herein generally refers to a structure capable of providing or obstructing access to a space by means of variable deployment.

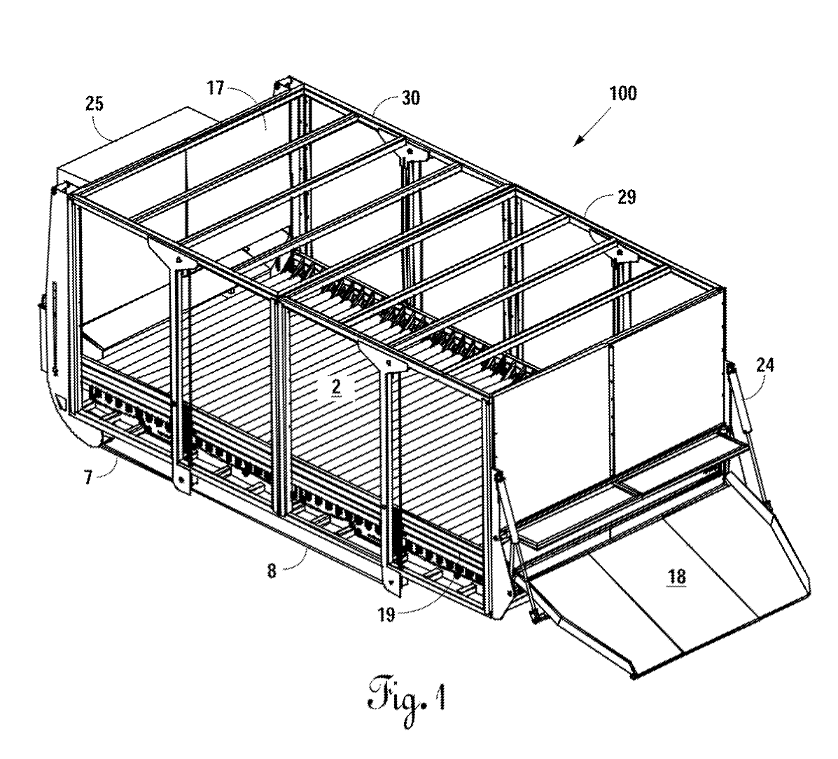

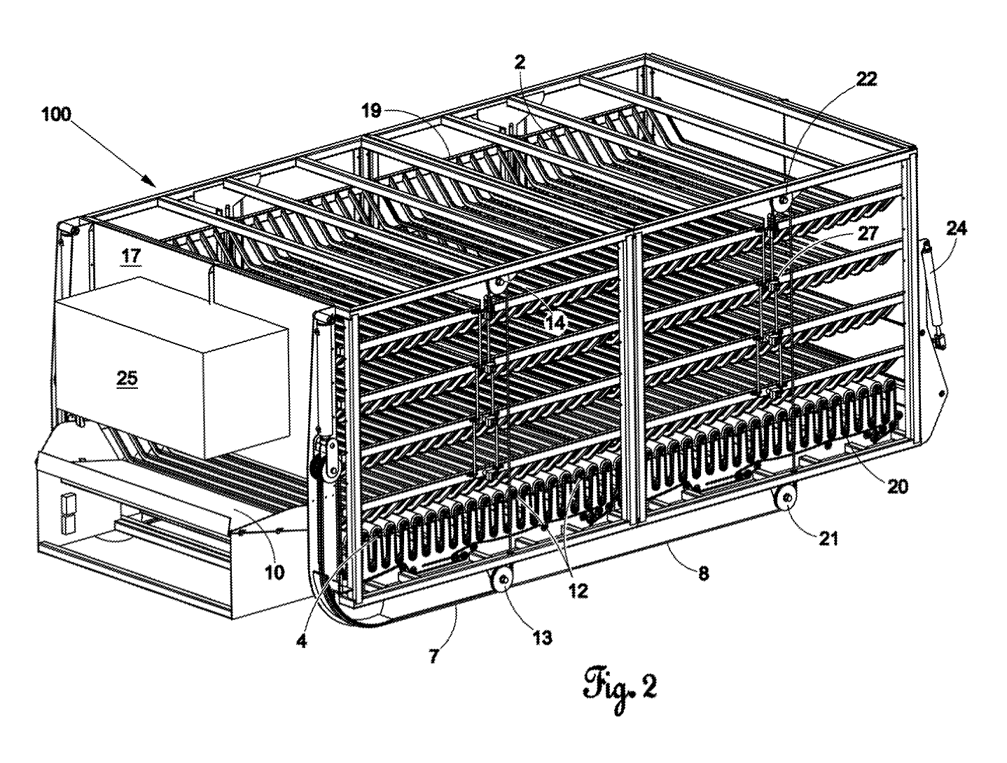

As shown in FIGS. 1 and 2, accumulator 100 has four baskets 2 and a brush bed 12. During harvest, produce is placed by workers on receiver 10, or placed on conveyors (not shown) that move the produce to receiver 10. Receiver 10 is approximately 14 inches above grade level, and is inclined downward toward brush bed 12 that consists of 22 roller brushes 4.

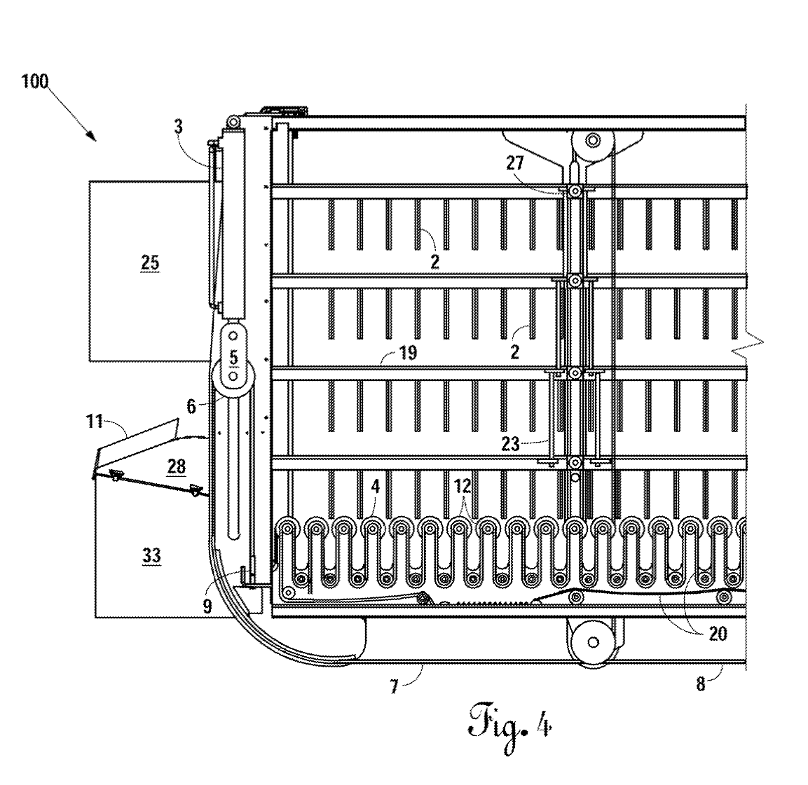

When produce fills brush bed 12, an operator causes a basket 2 to move upward, capturing the produce and elevating it to a predetermined level as shown in FIGS. 2 and 4. Wall 17 and tailgate 18 prevent the captured produce from falling off the front and rear of the accumulator, respectively. The basket sidewalls are angled outward at 45 degrees so that the basket side beams 19 will clear the brush beds while being raised and lowered. The 45 degree outward angle of the basket sidewalls permits the baskets to be lowered below the brushes when in the unloaded nested position, and also keeps the fruit from rolling out when in a raised loaded position. This design also helps force the fruit inward as the basket is raised. The resultant tight packing in the basket minimizes relative motion that can damage fruit during transport.

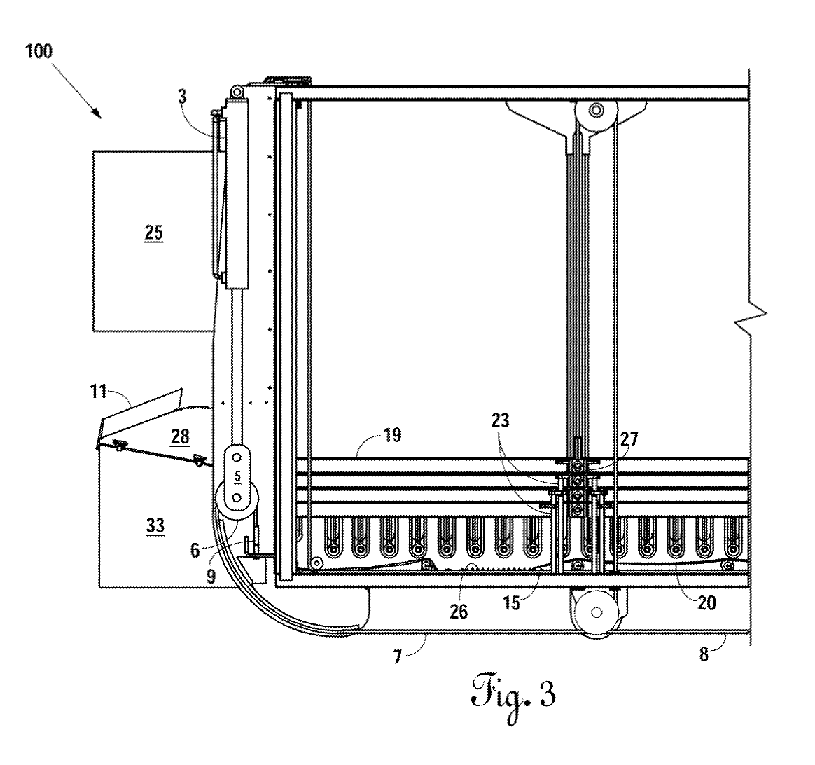

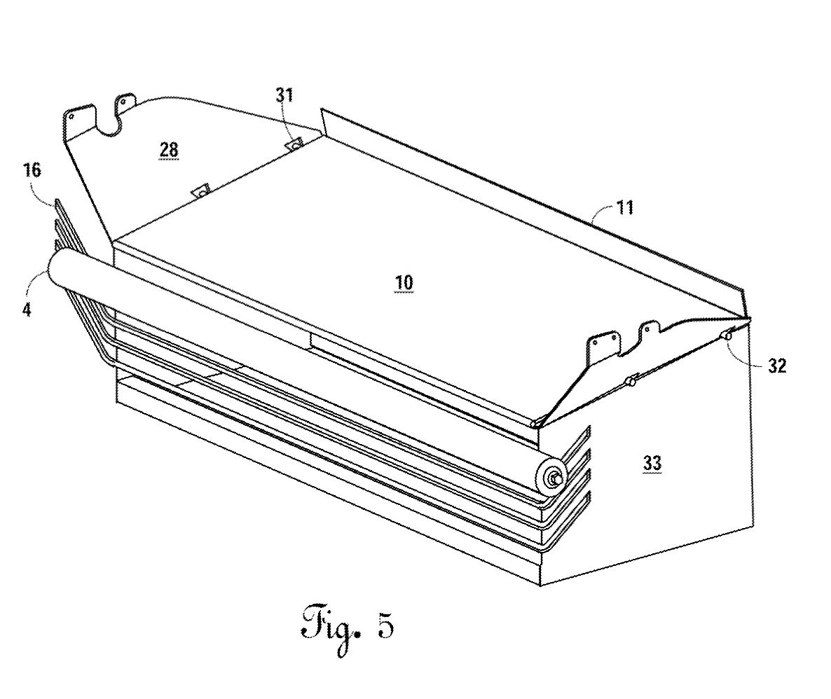

As shown in FIGS. 3, 4, and 5, receiver 10 is a substantially flat plate, the padded top of which receives melons that are placed directly by workers or by conveyors as the melons are loaded in the field. The receiver is located on the front end of the accumulator, and its front end is slightly higher than its rear end so that it slopes downward toward the roller brushes 4.

The front edge of receiver 10 is angled upward at least 8 inches to form a padded back-stop 11. Two pegs 32 that are attached to each side of receiver 10 rest in semicircular cutouts in the tops of receiver sidewalls 33. The pegs provide pivot points that allow the rear end of the receiver to move up and down in response to the slats 16 on the front end of the baskets as the baskets are raised and lowered during the accumulation process. As a basket is raised, its front slat catches the receiver rear edge and raises it, thus rolling any fruit that is not completely on the basket forward toward the padded receiver back-stop 11. When a loaded basket clears the brush bed sufficiently, typically about 13 inches, the front slat moves out from under receiver 10 that then pivots back down and allows melons to continue rolling onto the brush bed. During the unloading operation, as a loaded basket is lowered, its front slat engages the rear edge of receiver 10 and pivots it downward, thus preventing melons from rolling forward. The four notches 31 cut into receiver wings 28 provide clearance for the four pegs 32 as receiver 10 pivots.

Roller brushes 4 are 5 inches in diameter and 9 feet long, and are set on 5.71 inch centers. The brushes are manufactured by 3B Brush Company. Baskets 2 are constructed of welded 1×2 inch tubing. Accumulator frame construction is primarily welded 3 inch square tubing. All metal parts are painted with food grade paint. Overall accumulator height above grade level is 8 feet. Overall accumulator width is 11 feet. The overall length of a single accumulator module is 10 feet.

The brushes in the brush bed rotate in one direction under the influence of a continuous drive chain 20 illustrated in FIGS. 3 and 4. Reversing the direction of drive chain 20 reverses the direction of brush rotation. For the preferred embodiment, a 13 horsepower Honda engine coupled with an 8.3 gpm at 1250 psi hydraulic pump powers a White Hydraulics hydraulic motor that drives chain 20 with approximately four horsepower. The engine, pump, and their controls are housed in engine compartment 25 shown in FIGS. 2, 3, and 4. Drive chain 20 is tensioned by bolting a bracket that holds tensioning sprocket 15 in various tapped mounting holes 26 in the structure frame.

FIGS. 3 and 4 show baskets 2 in their lowered and raised positions, respectively. When the brush beds are filled with melons during the first accumulator operation, front hydraulic cylinder 3 raises clevis 5 holding dual pulley 6 that guides cables 7 and 8 that are dead-ended at cable anchor 9. There is an identical cylinder, pulley, and cable system on the opposite side of the accumulator. The two systems lift simultaneously. Such lifting action causes cables 7 and 8 to lift the top basket with the aid of pulleys 13, 14, 21, and 22.

Cylinder 3 and its mate are preset to lift the top basket through and above the brush bed a distance predetermined to provide adequate clearance for a particular crop; 15 inches is sufficient for watermelons. When the brush bed is filled with melons the second time, the lifting system raises the top basket the same distance it was raised the first time but the top basket also raises the second basket the same distance by means of slider rods 23. Low friction slider blocks 27 attached to the baskets slide in vertical channels in beams that are part of the frame structure. The loading and lifting operation is repeated until all baskets are full and in their raised positions.

FIG. 1 shows tailgate 18 deployed by rear hydraulic cylinders 24 as it would be when the accumulator is ready to perform its unloading function. As baskets 2 are sequentially lowered to the level of brush bed 12, brush rollers 4 are energized to rotate in the same direction as in the loading operation, and the melons are automatically unloaded onto receiving systems such as packing line conveyors (not shown). The brush variable speed chain drive system assures that loading and unloading speeds are at the operator's discretion.

The present invention can operate as a single accumulator module, but the preferred embodiment consists of two modules as depicted in FIGS. 1 and 2. Front module 30 and rear module 29 and their corresponding baskets are bolted together, and cable 8 is added for the additional power needed to raise and lower the combined baskets. The roller brushes in the rear module are driven by a second motor, the speed of which is synchronized with the motor driving the roller brushes in the front module. More than two modules can be used, the only limitation being the power available for lifting the baskets and driving the roller brushes.

It will be apparent to those with ordinary skill in the relevant art having the benefit of this disclosure that the present invention provides a novel apparatus for accumulating and unloading agricultural produce and other objects. It is understood that the form of the invention shown and described in the detailed description and the drawings is to be taken merely as the currently preferred embodiment, and that the invention is limited only by the language of the claims. The drawings and detailed description presented herein are not intended to limit the invention to the particular embodiment disclosed. While the present invention has been described in terms of one preferred embodiment, it will be apparent to those skilled in the art that form and detail modifications can be made to the described embodiment without departing from the spirit or scope of the invention.

With benefit of this disclosure and accompanying drawings, and without undue experimentation, all methods described herein can be performed and all apparatus described herein can be made and used.

I claim:

1. An apparatus comprising:
(a) a substantially rigid, substantially parallelepiped frame structure having a top, a bottom, a first end, and a second end;
(b) a substantially planar bed of parallel roller brushes, said brushes having predetermined spacing, horizontal longitudinal axes parallel to said first and second ends, and the capability to rotate in both directions about said horizontal axes;
(c) a plurality of stackable baskets parallel to, and capable of transportation through, said brush bed;
(d) a means for rotating said roller brushes about said horizontal axes in either said direction; and
(e) a means for individually transporting each said basket through said brush bed from beneath said brush bed to a predetermined distance above said brush bed.

2. An apparatus as in claim 1 further comprising a means for limiting said transportation of a said basket.

3. An apparatus as in claim 1 wherein said structure is modular.

4. An apparatus as in claim 1 wherein said structure is mounted on a trailer.

5. An apparatus as in claim 4 wherein said means for rotating said roller brushes and transporting each said basket through said brush bed is wholly contained on said trailer.

6. An apparatus as in claim 1 further comprising one or more conveyor belts attached to a said end of said structure.

7. An apparatus as in claim 1 further comprising a tailgate deployable from a said end of said structure.

8. An apparatus as in claim 1 further comprising a means for rotating said roller brushes simultaneously about said horizontal axes.

9. An apparatus as in claim 1 wherein said structure and said baskets are painted with food grade paint.
